(19) United States
(12) Patent Application Publication
(10) Pub. No.: US 2015/0319742 A1
(43) Pub. Date: Nov. 5, 2015

(54) RESOURCE ALLOCATION METHODS FOR CONTROL CHANNELS

(71) Applicants: Tommi Tapani KOIVISTO, Espoo (FI); Chunyan GAO, Xicheng District, Beijing (CN); BROADCOM CORPORATION, Irvine, CA (US)

(72) Inventors: Tommi Tapani KOIVISTO, Espoo (FI); Chunyan GAO, Beijing (CN)

(73) Assignee: BROADCOM CORPORATION, Irvine, CA (US)

(21) Appl. No.: 14/440,243

(22) PCT Filed: Nov. 3, 2012
(86) PCT No.: PCT/CN2012/084042

§ 371 Date: May 1, 2015

(51) Int. Cl. H04W 72/04

(52) U.S. Cl. CPC H04W 72/0406; H04W 72/044

(57) ABSTRACT

Embodiments include methods for allocating physical-layer (PHY) resources of a communication system for a control channel, including determining a set of resource allocation patterns, selecting at least one resource allocation pattern from the determined set, encoding a plurality of indices identifying each of the selected resource allocation patterns, wherein the plurality of indices comprises a first index identifying a selected resource group allocation and a second index identifying a selected resource block allocation, and sending a message comprising the plurality of indices for the selected resource allocation patterns. Other embodiments include methods for determining resource allocation patterns used to allocate PHY resources for a control channel, and methods for receiving an allocation of PHY resources for a control channel. Other embodiments include various apparatus and computer-readable media embodying one or more of the methods.

### TECHNICAL FIELD

The disclosure herein relates to the field of wireless or cellular communications, and more particularly to methods, devices, and network equipment that efficiently allocation physical-layer (PHY) resources of a communication system for a control channel.

### BACKGROUND

The Third Generation Partnership Project (3GPP) unites six telecommunications standards bodies, known as “Organizational Partners,” and provides their members with a stable environment to produce the highly successful Reports and Specifications that define 3GPP technologies. These technologies are constantly evolving through what have become known as “generations” of commercial cellular/mobile systems. 3GPP also uses a system of parallel “releases” to provide developers with a stable platform for implementation and to allow for the addition of new features required by the market. Each release includes specific functionality and features that are specified in detail by the version of the 3GPP standards associated with that release.

Universal Mobile Telecommunication System (UMTS) is an umbrella term for the third generation (3G) radio technologies developed within 3GPP and initially standardized in Release 4 and Release 99, which preceded Release 4. UMTS includes specifications for both the UMTS Terrestrial Radio Access Network (UTRAN) as well as the Core Network. UTRAN includes the original Wideband CDMA (W-CDMA) radio access technology that uses paired or unpaired 5-MHz channels, initially within frequency bands near 2 GHz but subsequently expanded into other licensed frequency bands. The UTRAN generally includes node-Bs (NBs) and radio network controllers (RNCs). Similarly, GSM/EDGE is an umbrella term for the second-generation (2G) radio technologies initially developed within the European Telecommunication Standards Institute (ETSI) but now further developed and maintained by 3GPP. The GSM/EDGE Radio Access Network (GERAN) generally comprises base stations (BTSs) and base station controllers (BSCs).

Long Term Evolution (LTE) is another umbrella term for so-called fourth-generation (4G) radio access technologies developed within 3GPP and initially standardized in Releases 8 and 9, also known as Evolved UTRAN (E-UTRAN). As with UMTS, LTE is targeted at various licensed frequency bands, including the 700-MHz band in the United States. LTE is accompanied by improvements to non-radio aspects commonly referred to as System Architecture Evolution (SAE), which includes Evolved Packet Core (EPC) network. LTE continues to evolve through subsequent releases. One of the features under consideration for Release 11 is an enhanced Physical Downlink Control Channel (ePDCCH), which has the goals of increasing capacity and improving spatial reuse of control channel resources, improving inter-cell interference coordination (ICIC), and supporting antenna beamforming and/or transmit diversity for control channel.

### SUMMARY

Embodiments of the present disclosure include a method for allocating physical-layer (PHY) resources of a communication system for a control channel, comprising determining a set of resource allocation patterns from among all available resource allocation patterns; selecting at least one resource allocation pattern from the determined set of resource allocation patterns; encoding a plurality of indices identifying each of the at least one selected resource allocation patterns, wherein the plurality of indices comprises a first index identifying a selected resource group allocation and a second index identifying a selected resource block allocation; and sending a message comprising the plurality of indices for each of the at least one selected resource allocation pattern. In some embodiments, each resource group allocation comprises one or more physical resource block groups (RBGs) and each resource block allocation comprises one or more physical resource blocks (PRBs) within the one or more RBGs. In some embodiments, the first index identifies one or more RBGs or one or more pairs of RBGs. In some embodiments, the second index identifies one or more PRBs comprising the resource groups identified by the first index, and the size of the second index is less than or equal to the number of PRBs per RBG. Other embodiments comprise apparatus (e.g., evolved Node B or component thereof) and computer-readable media embodying one or more of the methods.

Other embodiments of the present disclosure include methods for determining resource allocation patterns used to allocate PHY resources of a communication system for a control channel, comprising determining the PHY resources available for control channel communications; determining the allowed resource size for each control channel; determining a set of resource group allocation sizes based on the bandwidth of the PHY resources in the communication system, wherein each resource group allocation size represents the number of resource groups comprising one or more resource allocation patterns; determining, for each of the set of resource group allocation sizes, a set of resource group allocation patterns based on the allowed resource size and the resource group allocation size; determining a first index comprising a set of values, with each resource group allocation pattern determined for each of the set of resource group allocation sizes uniquely represented by one value in the set; determining a set of resource block allocation patterns, wherein the set of resource block allocation patterns correspond to each resource group allocation pattern represented by the first index; and determining a second index comprising a set of values, wherein each value uniquely represents one of the set of resource block allocation patterns, and wherein the size of the second index is less than or equal to the number of resource blocks per resource group.

In some embodiments, the resource groups comprising each resource group allocation pattern of a particular set are different than the resource groups comprising other resource group allocation patterns of the particular set. In some embodiments, the spacing between successive resource groups comprising a resource group allocation pattern is the same for all resource group allocation patterns comprising the particular set. In some embodiments, the resource group comprises one of a resource block group (RBG) and a pair of RBGs. Other embodiments include apparatus (e.g., evolved Node B or component thereof) and computer-readable media embodying one or more of the methods.

Other embodiments of the present disclosure include methods for receiving an allocation of physical-layer (PHY) resources of a communication system for a control channel, comprising: receiving a resource allocation message comprising a plurality of indices identifying one or more resource allocation pattern; for each of the at least one resource allocation patterns identified in the resource allocation message: determining one or more physical resource block groups (RBGs) corresponding to a first index associated with the resource allocation pattern, and determining one or more physical resource blocks (PRBs) within each of the one or more RBGs corresponding to a second index associated with the resource allocation pattern; selecting one of the one or more resource allocation patterns identified in the resource allocation message; and initiating control-channel communication using the PHY resources identified by the selected resource allocation pattern. In some embodiments, determining the one or more RBGs corresponding to the first index comprises determining a plurality of threshold values based on bandwidth of the PHY resource; selecting one of the plurality of threshold values based on the value of the first index; and determining the one or more RBGs based on the value of the first index, the selected threshold value, and the bandwidth of the PHY resource.

Other embodiments include apparatus (e.g., user equipment (UE) or component thereof) and computer-readable media embodying one or more of the methods. In some embodiments, the physical layer (PHY) comprises a Long Term Evolution (LTE) physical layer and the control channel comprises an enhanced Physical Downlink Control Channel (ePDCCH).

### DESCRIPTION OF THE DRAWINGS

The detailed description will refer to the following drawings, wherein like numerals refer to like elements, and wherein the following exemplary figures illustrate various embodiments without limitation:

FIG. 1 is a high-level block diagram of the architecture of the Long Term Evolution (LTE) Evolved UTRAN (E-UTRAN) and Evolved Packet Core (EPC) network, as standardized by 3GPP;

FIG. 2A is a high-level block diagram of the E-UTRAN architecture in terms of its constituent components, protocols, and interfaces;

FIG. 2B is a block diagram of the protocol layers of the control-plane portion of the radio (Uu) interface between a user equipment (UE) and the E-UTRAN;

FIG. 2C is a block diagram of the LTE radio interface protocol architecture from the perspective of the PHY layer;

FIG. 3 is block diagram of the type-1 LTE radio frame structure used for both full-duplex and half-duplex FDD operation;

FIG. 4 is a block diagram illustrating one manner in which control channel elements (CCEs) and resource element groups (REGs) for a PDCCH can be mapped to LTE physical resource blocks (PRBs);

FIG. 5 is a block diagram illustrating an exemplary mapping of PDCCH, ePDCCH, and PDSCH to virtual or physical resource blocks, according to embodiments of the present disclosure;

FIG. 6A is a resource allocation chart illustrating a method of allocating PHY-layer physical resource blocks for use in ePDCCH communications, according to one or more embodiments of the present disclosure;

FIG. 6B is a table showing the number of bits required for signaling exemplary resource allocation indices for various system bandwidths, according to one or more embodiments of the present disclosure;

FIGS. 7A and 7B are resource allocation charts illustrating a method of allocating PHY-layer physical resource blocks for use in ePDCCH communications, according to one or more other embodiments of the present disclosure;

FIG. 8A is a flowchart of an exemplary method for allocating physical-layer (PHY) resources of a communication system for a control channel, according to one or more embodiments of the present disclosure;

FIG. 8B is a flowchart of an exemplary method for determining resource allocation patterns used to allocate physical-layer (PHY) resources of a communication system for a control channel, according to one or more embodiments of the present disclosure;

FIG. 9 is a flowchart of an exemplary method for receiving allocation of physical-layer (PHY) resources of a communication system for a control channel, according to embodiments of the present disclosure;

FIG. 10 is a block diagram of a PHY-layer transmitter according to one or more embodiments of the present disclosure;

FIG. 11 is a block diagram of an exemplary communication device, such as a UE, according to one or more embodiments of the present disclosure; and

FIG. 12 is a block diagram of an exemplary network equipment, such as an eNB, according to one or more embodiments of the present disclosure.

### DETAILED DESCRIPTION

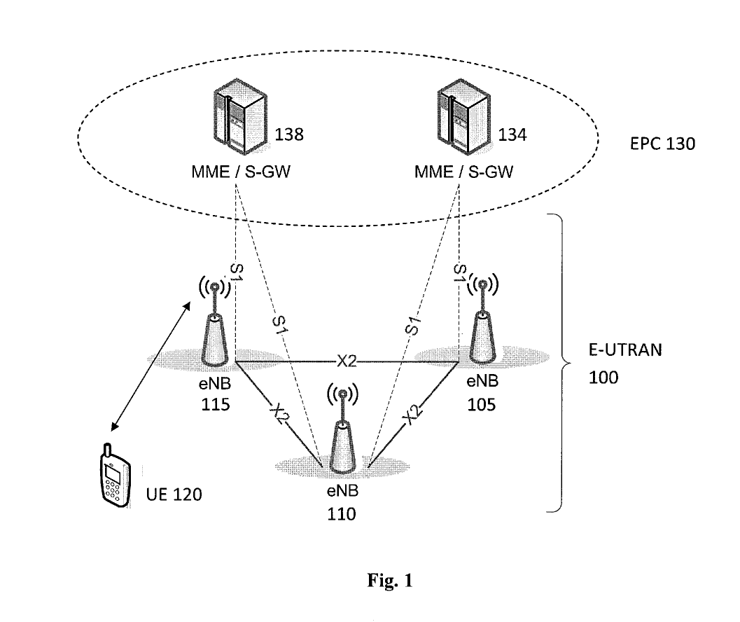

The overall architecture of a network comprising LTE and SAE is shown in FIG. 1. E-UTRAN 100 comprises one or more evolved Node B's (eNB), such as eNBs 105, 110, and 115, and one or more user equipment (UE), such as UE 120. As used within the 3GPP standards, “user equipment” or “UE” means any wireless communication device (e.g., smartphone or computing device) that is capable of communicating with 3GPP-standard-compliant network equipment, such as UTRAN, E-UTRAN, and/or GERAN, as the second-generation (“2G”) 3GPP radio access network is commonly known.

As specified by 3GPP, E-UTRAN 100 is responsible for all radio-related functions in the network, including radio bearer control, radio admission control, radio mobility control, scheduling, and dynamic allocation of resources to UEs in uplink and downlink, as well as security of the communications with the UE. These functions reside in the eNBs, such as eNBs 105, 110, and 115. The eNBs in the E-UTRAN communicate with each other via the X2 interface, as shown in FIG. 1. The eNBs also are responsible for the E-UTRAN interface to the EPC, specifically the S1 interface to the Mobility Management Entity (MME) and the Serving Gateway (SGW), shown collectively as MME/S-GWs 134 and 138 in FIG. 1. MME/S-GWs 134 and 138 comprise Evolved Packet Core (EPC) 130. Generally speaking, the MME/S-GW handles both the overall control of the UE and data flow between the UE and the rest of the EPC. More specifically, the MME processes the signaling protocols between the UE and the EPC, which are known as the Non Access Stratum (NAS) protocols. The S-GW handles all Internet Procotol (IP) data packets between the UE and the EPC, and serves as the local mobility anchor for the data bearers when the UE moves between eNBs, such as eNBs 105, 110, and 115.

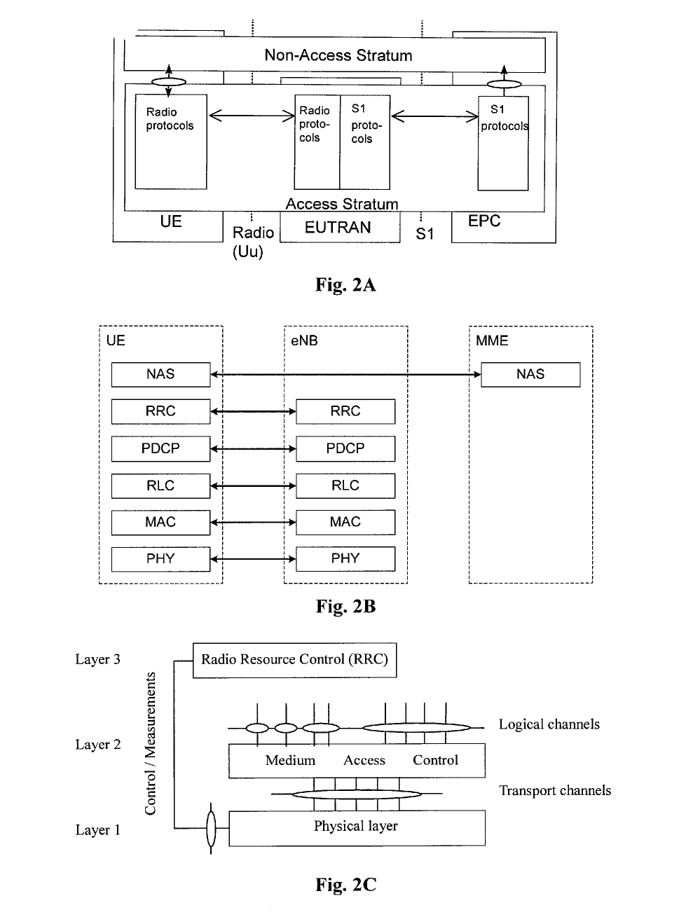

FIG. 2A is a high-level block diagram of LTE architecture in terms of its constituent entities—UE, E-UTRAN, and EPC—and high-level functional division into the Access Stratum (AS) and the Non-Access Stratum (NAS). FIG. 1 also illustrates two particular interface points, namely Uu (UE/E-UTRAN Radio Interface) and S1 (E-UTRAN/EPC interface), each using a specific set of protocols, i.e., Radio Protocols and S1 Protocols. Each of the two protocols can be further segmented into user plane (or “U-plane”) and control plane (or “C-plane”) protocol functionality. On the Uu interface, the U-plane carries user information (e.g., data packets) while the C-plane is carries control information between UE and E-UTRAN.

FIG. 2B is a block diagram of the C-plane protocol stack on the Uu interface comprising Physical (PHY), Medium Access Control (MAC), Radio Link Control (RLC), Packet Data Convergence Protocol (PDCP), and Radio Resource Control (RRC) layers. The PHY layer is concerned with how and what characteristics are used to transfer data over transport channels on the LTE radio interface. The MAC layer provides data transfer services on logical channels, maps logical channels to PHY transport channels, and reallocates PHY resources to support these services. The RLC layer provides error detection and/or correction, concatenation, segmentation, and reassembly, reordering of data transferred to or from the upper layers. The PHY, MAC, and RLC layers perform identical functions for both the U-plane and the C-plane. The PDCP layer provides ciphering/deciphering and integrity protection for both U-plane and C-plane, as well as other functions for the U-plane such as header compression.

FIG. 2C is a block diagram of the LTE radio interface protocol architecture from the perspective of the PHY. The interfaces between the various layers are provided by Service Access Points (SAPs), indicated by the ovals in FIG. 2C. The PHY layer interfaces with the MAC and RRC protocol layers described above. The MAC provides different logical channels to the RLC protocol layer (also described above), characterized by the type of information transferred, whereas the PHY provides a transport channel to the MAC, characterized by how the information is transferred over the radio interface. In providing this transport service, the PHY performs various functions including error detection and correction; rate-matching and mapping of the coded transport channel onto physical channels; power weighting, modulation; and demodulation of physical channels; transmit diversity, beamforming multiple input multiple output (MIMO) antenna processing; and providing radio measurements to higher layers, such as RRC. Downlink (i.e., eNB to UE) physical channels provided by the LTE PHY include Physical Downlink Shared Channel (PDSCH), Physical Multicast Channel (PMCH), Physical Downlink Control Channel (PDCCH), Relay Physical Downlink Control Channel (R-PDCCH), Physical Broadcast Channel (PBCH), Physical Control Format Indicator Channel (PCFICH), and Physical Hybrid ARQ Indicator Channel (PHICH).

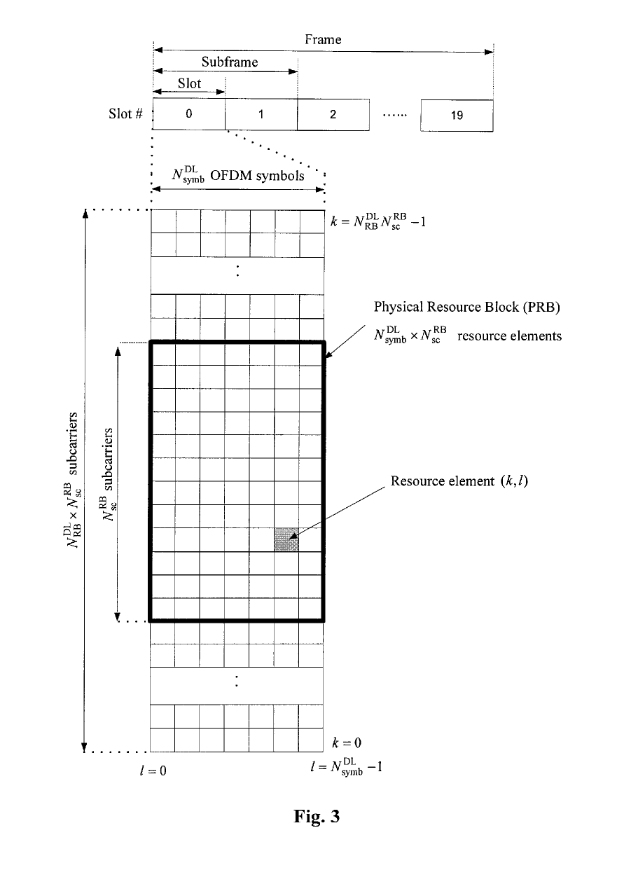

The multiple access scheme for the LTE PHY is based on Orthogonal Frequency Division Multiplexing (OFDM) with a cyclic prefix (CP) in the downlink, and on Single-Carrier Frequency Division Multiple Access (SC-FDMA) with a cyclic prefix in the uplink. To support transmission in paired and unpaired spectrum, the LTE PHY supports both: Frequency Division Duplexing (FDD) (including both full- and half-duplex operation) and Time Division Duplexing (TDD). FIG. 3 shows the radio frame structure (“type 1”) used for both full-duplex and half-duplex FDD operation. The radio frame has a duration of 10 ms and consists of 20 slots, labeled 0 through 19, each with a duration of 0.5 ms. A 1-ms subframe comprises two consecutive slots where subframe i consists of slots 2i and 2i+1. Each slot consists of N^{DL}_{symb} OFDM symbols, each of which is comprised of N_{sc} OFDM subcarriers. The value of N^{DL}_{symb} is typically 7 (with a normal CP) or 6 (with an extended-length CP) for subcarrier bandwidth of 15 kHz, or 3 (with a sub-carrier bandwidth of 7.5 kHz). The value of N_{sc} is configurable based upon the available channel bandwidth. Since persons of ordinary skill in the art will be familiar with the principles of OFDM, further details are omitted in this description.

As shown in FIG. 3, the combination of a particular subcarrier in a particular symbol is known as a resource element (RE). Each RE is used to transmit a particular number of bits, depending on the type of modulation and/or bit-mapping constellation used for that RE. For example, some REs may carry two bits using QPSK modulation, while other REs may carry four or six bits using 16- or 64-QAM, respectively. The radio resources of the LTE PHY are also defined in terms of physical resource blocks (PRBs). A PRB spans N^{RB}_{sc} sub-carriers over the duration of a slot (i.e., N^{DL}_{symb} symbols), where N^{RB}_{sc} is typically either 12 (with a sub-carrier bandwidth of 15 kHz) or 24 (with a sub-carrier bandwidth of 7.5 kHz). A PRB spanning the same N^{RB}_{sc} subcarriers during an entire subframe (i.e., 2N^{DL}_{symb} symbols) is known as a PRB pair. Accordingly, the resources available in a subframe of the LTE PHY downlink comprise N^{DL}_{RB} PRB pairs, each of which comprises 2N^{DL}_{symb}·N^{RB}_{sc} REs. For a normal CP and 15-KHz sub-carrier bandwidth, a PRB pair comprises 168 REs.

One characteristic of PRBs is that consecutively numbered PRBs (e.g., PRBᵢ and PRBᵢ₊₁) comprise consecutive blocks of subcarriers. For example, with a normal CP and 15-KHz sub-carrier bandwidth, PRB₀ comprises sub-carrier 0 through 11 while PRB₁ comprises sub-carries 12 through 23. The LTE PHY resource also can be defined in terms of virtual resource blocks (VRBs), which are the same size as PRBs but may be of either a localized or a distributed type. Localized VRBs are mapped directly to PRBs such that VRB n_{VRB} corresponds to PRB n_{PRB}=n_{VRB}. On the other hand, distributed VRBs may be mapped to non-consecutive PRBs according to various rules, as described in 3GPP Technical Specification (TS) 36.213 or otherwise known to persons of ordinary skill in the art. However, the term “PRB” will be used in this disclosure to refer to both physical and virtual resource blocks. Moreover, the term “PRB” will be used henceforth to refer to a resource block for the duration of a subframe, i.e., a PRB pair, unless otherwise specified.

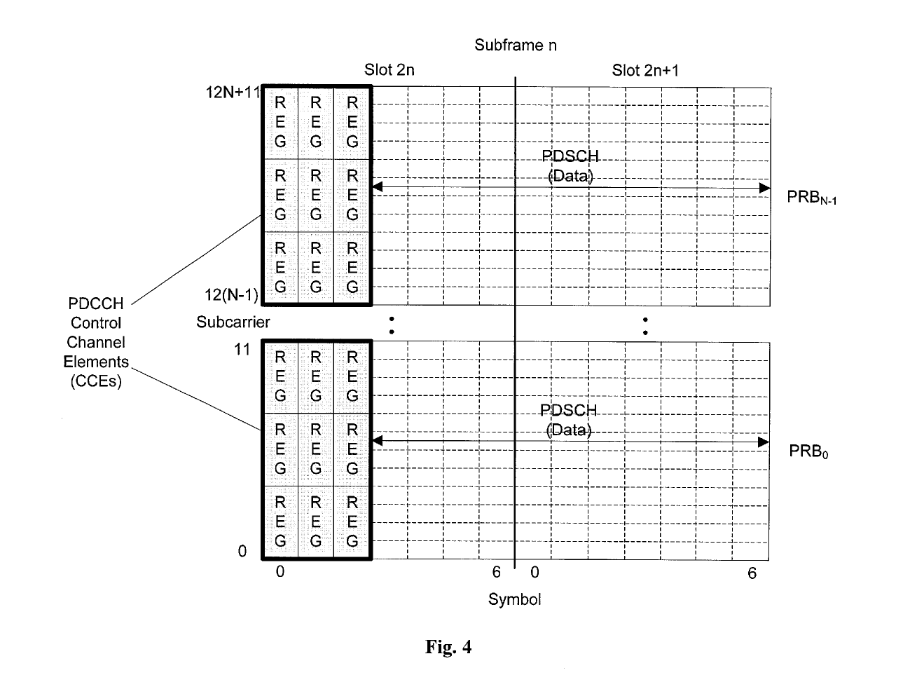

As mentioned above, the LTE PHY maps the various downlink physical channels to the resources shown in FIG. 3. For example, the PDCCH carries scheduling assignments and other control information. A physical control channel is transmitted on an aggregation of one or several consecutive control channel elements (CCEs), and a CCE is mapped to the physical resource shown in FIG. 3 based on resource element groups (REGs), each of which is comprised of a plurality of REs. For example, a CCE may be comprised of nine (9) REGs, each of which is comprised of four (4) REs. FIG. 4 illustrates one manner in which the CCEs and REGs can be mapped to the physical resource, i.e., PRBs. As shown in FIG. 4, the REGs comprising the CCEs of the PDCCH may be mapped into the first three symbols of a subframe, whereas the remaining symbols are available for other physical channels, such as the PDSCH which carries user data. Each of the REGs comprises four REs, which are represented by the small, dashed-line rectangles. Since QPSK modulation is used for the PDCCH, in the exemplary configuration of FIG. 4, each REG comprises eight (8) bits and each CCE comprises 72 bits. Although two CCEs are shown in FIG. 4, the number of CCEs may vary depending on the required PDCCH capacity, determined by number of users, amount of measurements and/or control signaling, etc. Moreover, other ways of mapping REGs to CCEs will be apparent to those of ordinary skill in the art.

Beginning with Release 11, the 3GPP specifications are planned to include an enhanced PDCCH (ePDCCH) in addition to the legacy PDCCH described above. The ePDCCH is intended to increase capacity and improve spatial reuse of control channel resources, improve inter-cell interference coordination (ICIC), and add antenna beamforming and/or transmit diversity support for control channel. Much like the Release 8 PDCCH, the ePDCCH is constructed by aggregating one or more enhanced control channel elements (eCCEs). An eCCE is comprised of one or more enhanced resource element groups (eREGs), each of which is comprised of one or more REs. For example, an eCCE comprised of nine eREGs, each having four REs, may be configured with the same capacity as a CCE. Unlike CCEs, however, eCCEs may be flexibly configured with various numbers and sizes of eREGs.

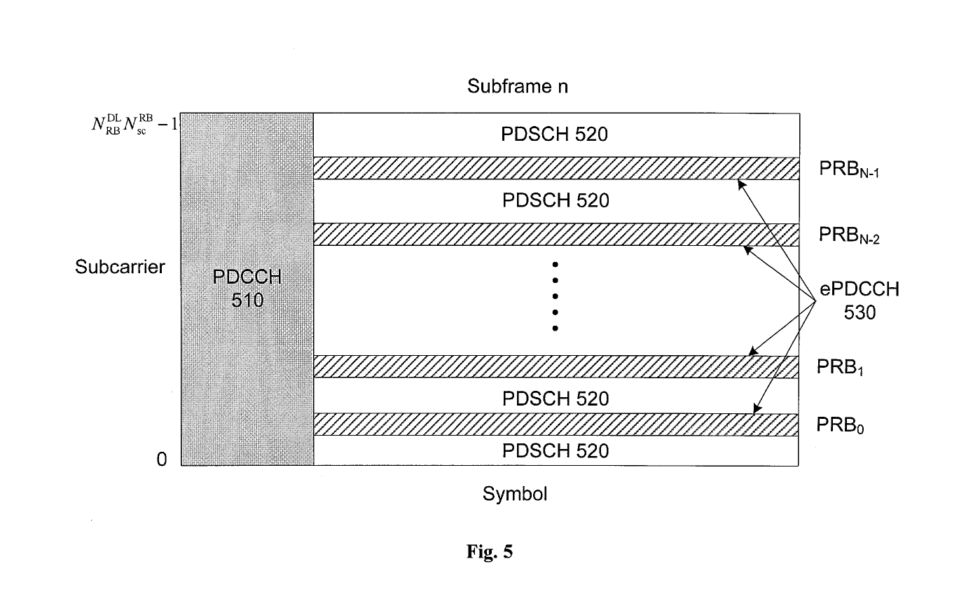

Moreover, the ePDCCH (i.e., eCCEs) may be mapped to PRBs for transmission either in a localized or distributed manner. The localized mapping provides frequency selective scheduling gain and beamforming gain while the distributed transmission provides robust ePDCCH transmission via frequency diversity in case valid channel state information is not available to the receiver. In order to achieve sufficient frequency diversity, however, each eCCE must be mapped to a minimum number PRBs distributed sufficiently throughout the range of sub-carriers in the physical resource. For example, each eCCE may be distributed among four PRBs spaced apart within the range of subcarriers. This example is illustrated in FIG. 5, which shows the PHY resource for a subframe, i.e., two slots. In this example, the first three symbols of the subframe consist of the PDCCH 510, as described above. The remainder of the PHY resource is divided between ePDCCH 530 and one or more PDSCHs 520. The PHY resource allocated to ePDCCH 530 is divided into one or more ePDCCH sets, each of which is comprised of N PRBs, where N is chosen from the set {2, 4, 8}. Currently, a maximum of K=2 ePDCCH sets may be allocated, which includes K_{L} localized ePDCCH sets of N PRBs and K_{D} distributed sets of PRBs. Accordingly, {K_{L}, K_{D}} may take on values of {0,1}, {1,0}, {1,1}, {0,2} and {2,0}. The example shown in FIG. 5 illustrates the case of {K_{L}, K_{D}}={0,1}, i.e., a single distributed ePDCCH set.

However, the problem of exactly how to allocate the PHY resource among the one or more ePDCCH sets remains unsolved. Since the PHY resource must be flexibly shared between the PDSCH and the ePDCCH, as seen in FIG. 5, any ePDCCH resource allocation scheme must be compatible with the PDSCH allocation scheme. Currently, three different PDSCH resource allocation scheme are defined in the 3GPP standard. PDSCH resource allocation type 0 allocates the PHY to PDSCH in resource block groups (RBGs), with each RBG consisting of consecutive PRBs (i.e., consecutive localized VRBs). The number of PRBs per RBG, P, ranges from one (1) to four (4) and is determined by the system bandwidth, i.e., N^{DL}_{RB} PRB pairs, as specified in 3GPP TS 36.213. However, this allocation scheme is not compatible with the range of N, the number of PRBs per ePDCCH set.

PDSCH resource allocation type 1 provides an indicator of a selected subset of available RBGs together with a bitmap indicating selection of PRBs within the selected subset. Although this approach provides great flexibility, it comes at a cost in terms of required signaling bandwidth that is too high for the requirements of the ePDCCH. On the other hand, PDSCH resource allocation type 2 assigns a starting PRB and a length of consecutive PRBs to the PDSCH. Compared to the requirements for ePDCCH resource allocation, this approach is both too restrictive due to the consecutive assignment, and too flexible due to the wide range of lengths available. Therefore, all three existing PDSCH resource allocation schemes suffer from at least these deficiencies that make them unsuitable for ePDCCH resource allocation.

Moreover, any resource allocation scheme for ePDCCH should balance the requirements of localized and distributed PRB transmission. In particular, for distributed transmission, the ideal ePDCCH resource allocation scheme should enable uniform spacing of resources in the frequency domain in order to exploit frequency diversity and frequency-selective scheduling gains. Likewise, for localized transmission, the ideal ePDCCH resource allocation scheme should support allocations spanning two adjacent PRBs, e.g., within a single RBG.

Various approaches have been proposed for allocating the PHY resource according to the requirements of the ePDCCH. Several 3GPP standards contributions, including R1-124200 and R1-124418, have proposed allocation schemes that meet flexibility requirements but at the expense of too much signaling overhead for informing the UE of the ePDCCH allocation. Anther 3GPP standard contribution, R1-1243762, uses an approach similar to PDSCH resource allocation type 0 and consequently suffers from similar deficiencies. Another 3GPP standards contribution, R1-124162, uses one bitmap to indicate the allocated EPDCCH RBGs and another bitmap to indicate the EPDCCH subset(s) in the allocated RBGs. Consequently, the granularity of each EPDCCH subset is fixed, causing the overlapping of the subsets to be overly restricted. A solution proposed in another 3GPP standards contribution, R1-12402, restricts allocation of ePDCCH PRB clusters such that they might not align on PRB boundaries, making PDSCH resource allocation too complex.

In summary, currently known solutions for ePDCCH resource allocation suffer from one or more deficiencies that make them unsuitable, including being too restrictive in allocation, creating unwanted difficulties for dividing the PHY resource between ePDCCH and PDSCH, and provide too much flexibility at the cost of excessive signaling overhead. These deficiencies are merely exemplary; the solutions described above may suffer from additional deficiencies, as may other solutions not discussed above. Various embodiments of the present disclosure solve these and other problems by providing methods for ePDCCH resource allocation that are compatible with the permitted values of N, the number of PRBs per EPDCCH set; require a minimum amount of signaling overhead to convey the allocation to the UE; and flexibly support the requirements for localized and distributed EPDCCH resource allocation. Embodiments also wireless communication devices (e.g., UEs), network equipment, and computer-readable media embodying one or more of these novel methods. These advantages provided by one or more of the disclosed embodiments are merely exemplary, and the person of ordinary skill may recognize additional advantages after reading the disclosure herein.

In one embodiment, the method comprises defining a plurality of ePDCCH RBG selection patterns. Each selection pattern identifies M selected RBGs from the total system bandwidth of N_{RBG} RBGs, which is computed by dividing the system bandwidth of N^{DL}_{RB} PRBs by P, the number of PRBs per RBG (which itself is determined according to the value of N^{DL}_{RB}, as discussed above). The value of M is chosen from among {1, 2, 4, 8}, or a subset thereof depending on the system bandwidth. For example, M may be constrained to be chosen from the set {1, 2} if the system bandwidth N^{DL}_{RB} amounts to less than 5 MHz. The set of M selected RBGs are further constrained to have equal spacing of N_{RBG}/M between successively selected RBGs. For example, M=1 corresponds to only a single selected RBG while M=2 corresponds to two selected RBGs spaced apart by N_{RBG}/2.

The method further comprises computing an RBG selection pattern index, I_{RP}, that identifies which of the available RBGs contain PRBs that are selected for allocation to the ePDDCH. The index I_{RP} comprises a sufficient number of values to identify each of the allowable combinations of M RBGs. For example, if the set {1, 2} comprises the allowable values for M, I_{RP} preferably comprises a sufficient number of values to identify each of the N_{RBG} individual RBGs (i.e., M=1) and each of the allowable combinations of two RBGs spaced apart by N_{RBG}/2 (i.e., M=2).

The method further comprises computing an intra-RBG selection index, I_{PRB}, that identifies which of the PRBs within the RBGs identified by I_{RP} are allocated to the ePDCCH. In some embodiments, each value of index I_{PRB} uniquely corresponds to a single one of the P PRBs within an RBG, such that I_{PRB} requires at least ceil(log₂ P) bits to identify each of the P PRBs. In some embodiments, index I_{PRB} comprises a bitmap of P bits such that each bit of I_{PRB} uniquely corresponds to one of the P PRBs comprising each of the identified RBGs. In such case, the value of each bit of I_{PRB} determines whether the corresponding PRB is allocated within each of the RBGs identified by I_{RP}. In some embodiments, the method comprises computing a single index I_{PRB} that identifies the same PRB within all of the one or more RBGs identified by index I_{RP}. After computing values for I_{RP} and I_{PRB}, the network sends these values to a communication device (e.g., a UE) that requires allocation of ePDCCH resources. The set of allowable values of M may be sent together with the indices, in a separate message (e.g., broadcast to all devices), or implicitly understood between the network and receiving devices (e.g., based on values of other parameters, such as N^{DL}_{RB}).

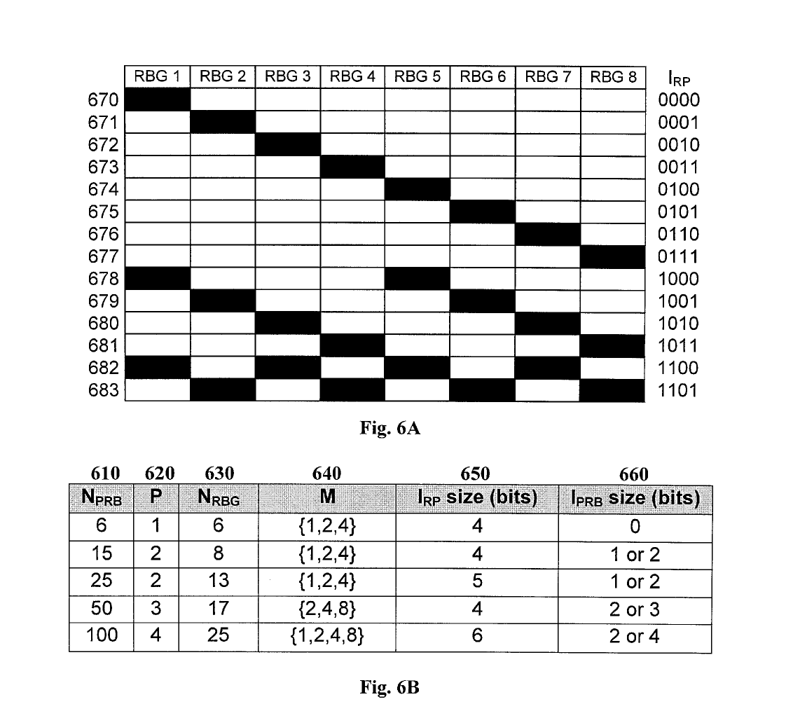

FIG. 6A illustrates the correspondence between values of the RBG selection pattern index and selected RBGs of the embodiments described above for the case of a system bandwidth of N_{RBG}=8 RBGs. According to the 3GPP TS 36.213, this corresponds to P=2 PRBs per RBG and a system bandwidth of N^{DL}_{RB}=15 PRBs. In this example, the value of M is chosen from among {1, 2, 4}. The various values of index I_{RP} for this example are shown in the left-most column of the diagram, and the one or more selected RBGs corresponding to each index value are indicated by the shaded blocks in the same row. For example, I_{RP} values 0000 through 0111, respectively, correspond to various single (M=1) RBGs selected from among the N_{RBG}=8 available RBGs, shown in rows 670 through 677. Likewise, I_{RP} values 1000 through 1011, respectively, correspond to four possible combinations of M=2 selected RBGs shown in rows 678 through 681, while I_{RP} values 1100 through 1101 correspond to the two possible combinations of M=4 selected RBGs shown in rows 682 and 683. In this example, the intra-RBG selection index, I_{PRB}, comprises a single bit whose value indicates which of the P=2 PRBs of each RBG identified by the RBG selection pattern index, I_{RP}, are allocated for the ePDCCH.

FIG. 6B is a table showing the number of bits required for signaling the indices I_{RP} for various system bandwidths, further illustrating the embodiments described above. Various system bandwidths expressed as the number of PRBs, N_{PRB}, are shown in the left-most column 610. Column 620 shows exemplary values of the number of PRBs per RBG, P, which depends on the system bandwidth. Column 630 shows the system bandwidth expressed as the number of RBGs, N_{RBG}. Column 640 shows exemplary sets of values from which M may be chosen for each of the system bandwidths. For example, for system bandwidths less than N_{PRB}=26, M is chosen from among the set (1, 2, 4}. Column 650 shows the size (i.e., number of bits) of the index I_{RP} required to signal all combinations of RBGs corresponding to the allowed values of M. Likewise, column 660 shows the size of the index I_{PRB} required to signal the allocated PRBs within the RBGs indicated by index I_{RP}, depending on the embodiment.

In another embodiment, the communication device receives the indices I_{RP} and I_{PRB} and uses them to determine which of the available N_{RBG} RBGs are selected, and which of the P PRBs within the selected RBGs are allocated for it to use for ePDCCH communications. Initially, the device determines a set of threshold values Kᵢ=Kᵢ₋₁+ceil[N_{RBG}/2⁽ⁱ⁻¹⁾], where K₀=0; i=1, 2, . . . L_{M}; and L_{M} is the number of allowed values of M. For example, if M is chosen from the set {1, 2}, L_{M}=2 and the device determines values K₁=N_{RBG} and K₂=N_{RBG}+ceil(N_{RBG}/2). By way of further example, if M is chosen from {1, 2, 4, 8}, L_{M}=4 and the device determines values K₁=N_{RBG}, K₂=K₁+ceil(N_{RBG}/2), K₃=K₂+ceil(N_{RBG}/4), and K₄=K₃+ceil(N_{RBG}/8). The set of allowable values of M may be received by the device together with the indices, received in a separate message (e.g., broadcast message), or implicitly understood between the network and receiving devices (e.g., based on values of other parameters, such as N^{DL}_{RB}).

After determining the threshold values, the uses the received index I_{RP} and threshold values to determine the RBGs containing PRBs allocated to it for ePDCCH use. In some embodiments, the device determines which of the threshold values Kⱼ satisfies the inequality Kⱼ≦I_{RP}<Kⱼ₊₁. In the case of M chosen from the set {1, 2}, it will be known that only K₁ satisfies this inequality, so in such case the device may skip this step. After determining Kⱼ, the device then determines the initial allocated RBG as X₁=(I_{RP}−Kⱼ)+1, and subsequent allocated RBGs as Xᵢ=X₁+(i−1)·N_{RBG}/2^{j}, i=2, 3, . . . M, where M is determined such that X, does not exceed N_{RBG}. For example, if M is chosen from the set {1, 2}, then the device will determine one RBG (X₁) or two RBGs (X₁ and X₂) having PRBs allocated for ePDCCH use, depending on the value of I_{RP}.

Subsequently, the device uses the received index I_{PRB} to determine which of the PRBs within the identified RBGs Xi are allocated for ePDCCH use. In one embodiment, the value of index I_{PRB} identifies a single PRB at the same position within each of the RBGs Xᵢ. For example, if each RBG comprises P PRBs, index I_{PRB} may comprise ceil(log₂ P) bits representing P decimal values, each uniquely corresponding to one of the P PRBs comprising Xᵢ. In other embodiments, index I_{PRB} comprises a bitmap of P bits such that each bit of I_{PRB} uniquely corresponds to one of the P PRBs comprising each of the determined RBGs. In such case, the value of each bit of I_{PRB} determines whether the corresponding PRB is allocated within each of the RBGs Xᵢ. After determining the particular RBGs and constituent PRBs allocated within the PHY resource for ePDCCH use, the device may transmit and receive appropriate control messages using these allocated PHY resources.

In another embodiment, a method comprises defining a plurality of ePDCCH RBG pair selection patterns. Each selection pattern identifies M RBG pairs from floor(N_{RBG}/2) available RBG pairs (determined according to the value of N^{DL}_{RB}, as discussed above). Each RBG pair comprises two RBGs that are spaced apart by floor(N_{RBG}/2) RBGs. The value of M is chosen from among {1, 2, 4, 8} or a subset thereof, depending on the system bandwidth. For example, M may be constrained to be chosen from the set {1, 2} or the set {1, 2, 4} if the system bandwidth N^{DL}_{RB} amounts to less than 26 PRBs. The set of M selected RBG pairs are further constrained to have equal spacing of N_{RBG}/(2·M) between successively selected RBG pairs. For example, M=1 corresponds to only a single selected RBG pair while M=2 corresponds to two selected RBG pairs spaced apart by N_{RBG}/4 RBG pairs.

The method further comprises computing an RBG selection pattern index, I_{RP}, that identifies which of the available RBG pairs contain PRBs that are selected for allocation to the ePDDCH. The index I_{RP} comprises a sufficient number of values to identify each of the allowable combinations of M RBG pairs. For example, if the set {1, 2} comprises the allowable values for M, I_{RP} preferably comprises a sufficient number of values to identify each of the N_{RBG}/2 individual RBG pairs (i.e., M=1) and each of the allowable combinations of two RBG pairs spaced apart by N_{RBG}/4 (i.e., M=2).

The method further comprises computing an intra-RBG pair selection index, I_{PRB}, that identifies which of the PRBs comprising the RBG pairs identified by I_{RP} are allocated to the ePDCCH. In some embodiments, the method comprises computing a single index I_{PRB} that identifies the same one or more PRBs within all of the RBG pairs or identified by index I_{RP}. In some embodiments, each value of I_{PRB} may correspond to a single one of the PRBs within an RBG pairs (i.e., 2·P PRBs), such that I_{PRB} requires at least ceil(log₂ 2P) bits to identify each of the P PRBs. In some embodiments, index I_{PRB} comprises a bitmap of 2·P bits such that each bit of I_{PRB} uniquely corresponds to one of the 2·P PRBs comprising each of the identified RBG pairs. In such case, the value of each bit of I_{PRB} determines whether the corresponding PRB is allocated within each of the RBG pairs identified by I_{RP}.

In some embodiments, each value of I_{PRB} may correspond to a single one of the PRBs within each RBG of the identified RBG pairs, such that I_{PRB} requires at least ceil(log₂ P) bits to identify each of the P PRBs. In other words, each value of I_{PRB} identifies the same PRB in each RBG of an RBG pair. In some embodiments, index I_{PRB} comprises a bitmap of P bits such that each bit of I_{PRB} uniquely corresponds to one of the P PRBs comprising each RBG of the identified RBG pairs. In other words, the value of each bit of I_{PRB} determines whether the corresponding PRB is allocated within each RBG of each RBG pair identified by I_{RP}. Regardless, after computing values for indices I_{RP} and I_{PRB}, the network sends these values to a communication device (e.g., a UE) that requires allocation of ePDCCH resources. The set of allowable values of M may be sent together with the indices, in a separate message (e.g., broadcast to all devices), or implicitly understood between the network and receiving devices.

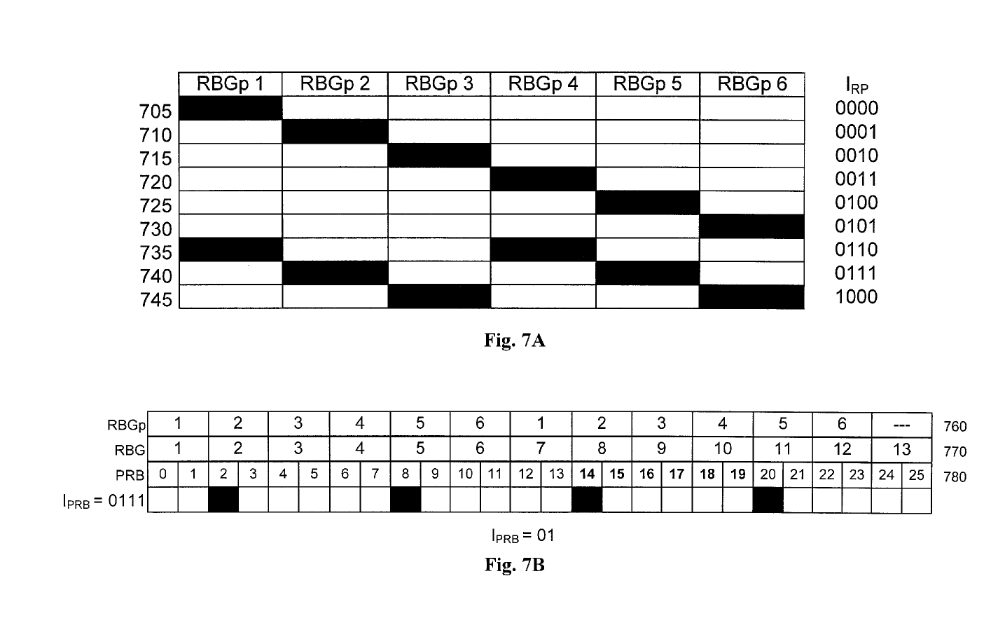

FIG. 7A illustrates the correspondence between values of the RBG selection pattern index and selected RBG pairs of the embodiments described above for the case of a system bandwidth of N_{RBG}=13 RBGs, corresponding to six RBG pairs. According to the 3GPP TS 36.213, this corresponds to P=2 PRBs per RBG and a system bandwidth of N^{DL}_{RB}=26 PRBs. In this example, the value of M is chosen from among the set {1, 2}, but persons of ordinary skill will be able to apply the techniques illustrated by this example to other embodiments comprising different sets. The various values of index I_{RP} for this example are shown in the left-most column of the diagram, and the one or more selected RBG pairs corresponding to each index value are indicated by the shaded blocks in the same row. For example, I_{RP} values “0000” through “0101”, respectively, correspond to various single (M=1) RBG pairs selected from among the floor(N_{RBG}/2)=6 available RBG pairs shown in rows 705 through 730. Likewise, I_{RP} values “0110” through “0111”, respectively, correspond to two possible combinations of M=2 selected RBG pairs shown in rows 735 and 740.

FIG. 7B further illustrates how individual PRBs are selected within the RBG pairs using the indices I_{RP} and I_{PRB}, based on the example shown in FIG. 7A (i.e., N_{RBG}=13 RBGs, six RBG pairs, P=2 PRBs per RBG, and a system bandwidth of N^{DL}_{RB}=26 PRBs). The values in row 780 indicate the respective PRBs, the values in row 770 indicate the respective RGBs, and the values in row 760 indicate the respective RBG pairs. In FIG. 7B, the value of I_{RP} is “0111” and the value of two-bit bitmap I_{PRB} is “01”. This combination of values indicates the second and fifth RBG pairs (i.e., RBGs 2, 5, 8, and 11) and the first of the two PRBs within each RBG of the indicated RBG pair (i.e., PRBs 2, 8, 14, and 20). Alternately, if I_{PRB} is a single-bit index, the value “0” would indicate that the first of the two PRBs in each RBG is allocated, as shown in the figure.

In another embodiment, the communication device receives the indices I_{RP} and I_{PRB} and uses them to determine which of the available N_{RBG}/2 RBG pairs are selected, and which of the 2·P PRBs within the selected RBG pairs are allocated for it to use for ePDCCH communications. Initially, the device determines a set of threshold values Kᵢ=Kᵢ₋₁+floor(N_{RBG}/2ⁱ), where K₀=0; i=1, 2, . . . L_{M}; and L_{M} is the number of allowed values of M. For example, if M is chosen from the set {1, 2}, L_{M}=2 and the device determines values K₁=floor(N_{RBG}/2) and K₂=K₁+floor(N_{RBG}/4). By way of further example, if M is chosen from {1, 2, 4}, L_{M}=3 and the device determines values K₁=floor(N_{RBG}/2), K₂=K₁+floor(N_{RBG}/4), and K₃=K₂ floor(N_{RBG}/8). The set of allowable values of M may be received by the device together with the indices, received in a separate message (e.g., broadcast message), or implicitly understood between the network and receiving devices (e.g., based on values of other parameters, such as N^{DL}_{RB}).

After determining the threshold values, the device uses the received index I_{RP} and threshold values to determine the RBG pairs containing PRBs allocated to it for ePDCCH use. In some embodiments, the device determines which of the threshold values Kⱼ satisfies the inequality Kⱼ≦I_{RP}<Kⱼ₊₁. In the case of M chosen from the set {1, 2}, it will be known that only K₁ satisfies this inequality, so in such case the device may skip this step. After determining Kⱼ, the device then determines the initial RBG pair as X₁=(I_{RP}−Kⱼ)+1, and subsequent RBG pairs as Xᵢ=X₁+(i−1)·floor(N_{RBG}/2^{(j+1)}, i=2, 3, . . . M, where M is determined such that Xᵢ does not exceed N_{RBG}/2. For example, if M is chosen from the set {1, 2}, then the device will determine one RBG pair (X₁) or two RBG pairs (X₁ and X₂) comprising PRBs allocated for ePDCCH use, depending on the value of I_{RP}.

Subsequently, the device uses the received index I_{PRB} to determine which of the PRBs within the identified RBG pairs Xᵢ are allocated for ePDCCH use. In some embodiments, the index I_{PRB} comprises a single value that identifies the same one or more PRBs within all of the RBG pairs identified by index I_{RP}. In some embodiments, each value of I_{PRB} may correspond to a single one of the 2·P PRBs within each RBG pair identified by index I_{RP}. In some embodiments, index I_{PRB} comprises a bitmap of 2·P bits such that each bit of I_{PRB} uniquely corresponds to one of the 2·P PRBs comprising each of the identified RBG pairs. In such case, the value of each bit of I_{PRB} determines whether the corresponding PRB is allocated within each of the RBG pairs identified by I_{RP}.

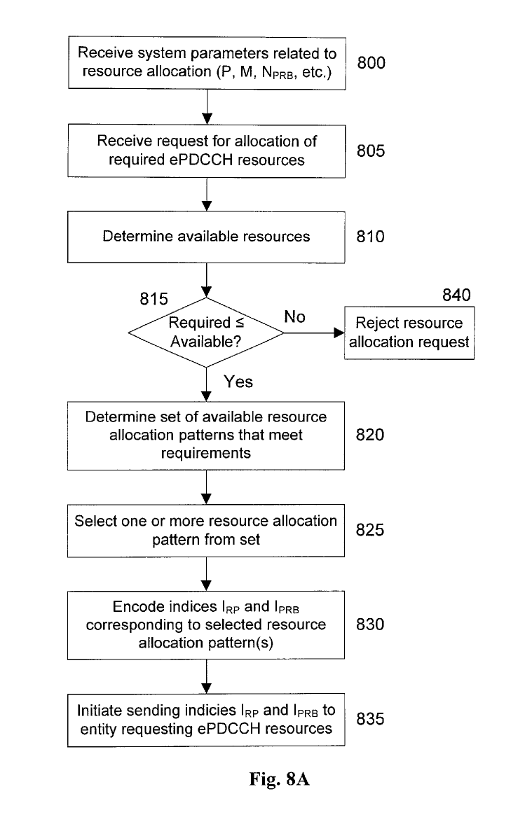

In some embodiments, each value of I_{PRB} may correspond to a single one of the PRBs within each RBG of the identified RBG pairs. In other words, each value of I_{PRB} identifies the same PRB in each RBG of an RBG pair. In some embodiments, index I_{PRB} comprises a bitmap of P bits such that each bit of I_{PRB} uniquely corresponds to one of the P PRBs comprising each RBG of the RBG pairs identified by index I_{RP}. In other words, the value of each bit of I_{PRB} determines whether the corresponding PRB is allocated within each RBG of each RBG pair identified by I_{RP}. Regardless, after determining the particular RBG pairs and constituent PRBs allocated within the PHY resource for ePDCCH use, the device may transmit and receive appropriate control messages using these allocated PHY resources. FIG. 8A is a exemplary method for allocating physical-layer (PHY) resources of a communication system for a control channel, according to one or more embodiments of the present disclosure. In some embodiments, the operations illustrated by FIG. 8A may be carried out by an apparatus such as an eNB, a component of an eNB, or the combination of an eNB with other network components. In other embodiments, the operations illustrated by FIG. 8A may be carried out by an apparatus such as a user equipment (UE) or component thereof (e.g., a modem). Although FIG. 8A illustrates the one or more embodiments by blocks arranged in a specific order, this order is merely exemplary and the steps or operations comprising the method may be performed in a different order than shown in the figure. Moreover, a person of ordinary skill will understand that the blocks shown in FIG. 8A may be combined and/or divided into blocks having different functionality. In block 800, the apparatus receives the system parameters that influence the PHY-layer resource allocation method, including P, the set of available M, N_{PRB}, etc. In some embodiments, the apparatus may receive these parameters from another apparatus, e.g., another eNB in the E-UTRAN. In other embodiments, the apparatus may establish these parameters and distribute them to other apparatus. These operations may occur immediately prior to starting the operations of other blocks in FIG. 8A, or substantially in advance of such operations.

In block 805, the apparatus receives a request for allocation of required ePDCCH resources. This request may comprise a minimum or an expected amount of resources needed for messages planned or expected to be transmitted and/or received via the ePDCCH. The request may be received from a higher layer, such as the RRC layer, through a PHY-layer service access point (SAP), as illustrated in FIG. 2C. In block 810, the apparatus determines the PHY-layer resources available for ePDCCH allocation. This operation may comprise determine the number of PRBs available, the configuration or layout of available PRBs, etc. This operation may also comprise determining PHY-layer resources required for other pending requests that have not yet been allocated resources.

In block 815, the apparatus compares the require resources indicated in the message received in block 805, with the available resources determined in block 810. If the required resources are greater than the available resources, the apparatus proceeds to block 840 where it initiates a rejection of the request. This may comprise notifying the requesting higher layer (e.g., the RRC layer) of the rejection of the resource request. If the request was originated by a communication device (e.g., a UE), the higher layer may communicate the rejection to the device via appropriate messages (e.g., RRC messages). On the other hand, if the required resources are less than or equal to the available resources, the apparatus proceeds to block 820 where it determines the set of available resource allocation patterns that meets the requirements. This operation may comprise comparing the available resources to each set of resources identified by allocation patterns corresponding to a plurality of values for indices I_{RP} and I_{PRB} (described above). This operation may comprise identifying a set of suitable resource allocation patterns corresponding to a plurality of values for indices I_{RP} and I_{PRB}. In some embodiments, indices I_{RP} and I_{PRB} may correspond, respectively, to a set of selected RBGs and one or more PRBs comprising the selected RBGs. In other embodiments, indices I_{RP} and I_{PRB} may correspond, respectively, to a set of selected RBG pairs and one or more PRBs comprising the selected RBG pairs.

In block 825, the apparatus selects one or more resource allocation patterns from among the set of suitable allocation patterns identified in block 820. In some embodiments, this operation comprises selecting a single resource allocation pattern from the set identified in block 820. In other embodiments, this operation may comprise selecting multiple resource allocation patterns (e.g., two or three) from the set identified in block 820. This operation may comprise selecting the one or more resource allocation patterns that is (are) optimal in some way, such as the pattern that leaves the largest block of the PHY-layer resource available for filling other request for ePDCCH and PDSCH resources, the pattern that is optimal for UE power consumption, etc. In block 830, the apparatus encodes the indices I_{RP} and I_{PRB} corresponding to the one or more resource allocation patterns selected in block 825. This operation may comprise any of the encoding methods described above with reference to FIGS. 6, 7A, and 7B. In block 835, the apparatus initiates the sending of a message comprising one or more pairs of indices I_{RP} and I_{PRB} to the entity requesting the ePDCCH resources. For example, the apparatus may initiate sending of the message, which is carried out by another apparatus, component, or piece of equipment in the same communication network. By way of further example, this message may be sent to a higher layer (e.g., the RRC layer) in the protocol stack through a service access point, as illustrated in FIG. 2C. Ultimately, the message comprising the indices may be sent to a communication device (e.g., a UE) via appropriate higher-layer messaging.

FIG. 8B is a flowchart of an exemplary method for determining resource allocation patterns used to allocate physical-layer (PHY) resources of a communication system for a control channel, according to one or more embodiments of the present disclosure. In some embodiments, the operations illustrated by FIG. 8B may be carried out by an apparatus such as an eNB, a component of an eNB, or the combination of an eNB with other network components. In other embodiments, the operations illustrated by FIG. 8B may be carried out by an apparatus such as a user equipment (UE) or component thereof (e.g., a modem). Although FIG. 8B illustrates the one or more embodiments by blocks arranged in a specific order, this order is merely exemplary and the steps or operations comprising the method may be performed in a different order than shown in the figure. Moreover, a person of ordinary skill will understand that the blocks shown in FIG. 8B may be combined and/or divided into blocks having different functionality.

In block 850, the apparatus determines the PHY resources available for control channel communications. This may comprise, for example, computing a predetermined fraction of the total PHY resources of the communication system, or computing a portion of the total PHY resources not utilize for other communications, such as user data communications (e.g., PDSCH). In block 855, the apparatus determines the allowed resource size for a control channel. This may be determined, for example, based on the determination made in block 850 and at least one of a minimum, maximum, expected, or desired number of control channels that are being utilized and/or to be utilized. The allowed resource size may comprise a plurality of PRBs or RBGs.

In block 860, the apparatus determines a set of resource group allocation sizes. Each resource group allocation size represents the number of resource groups (e.g., RBGs or RBG pairs) comprising one or more resource allocation patterns that can be used for allocating PHY resources for a control channel. This set may be determined, for example, based on the bandwidth of the PHY resources in the communication system (e.g., the bandwidth in terms of PRBs). In block 865, the apparatus determines, for each of the set of resource group allocation sizes determined in block 860, a set of resource group allocation patterns based on the allowed resource size determined in block 855 and the particular resource group allocation size, as described above and illustrated by the examples of FIGS. 6 and 7.

In block 870, the network device determines a first index comprising a set of values. In some embodiments, each resource group allocation pattern determined in block 860 is uniquely represented by one value in the set of values comprising the first index. An example of such an index is I_{RP}, which is described above and illustrated in the exemplary embodiments shown in FIGS. 6 and 7. In block 875, the apparatus determines a set of resource block allocation patterns. In some embodiments, the set of resource block allocation patterns correspond to each resource group allocation pattern represented by the first index, e.g., I_{RP}. For example, the resource block allocation patterns determined in block 875 may be applied in the same manner to each and every resource group allocation pattern represented by I_{RP}. In some embodiments, the resource block allocation patterns determine which of the resource blocks (e.g., PRBs) within every resource block group (e.g., RBG or RBG pair) is allocated for use in the control channel.

In block 880, the apparatus determines a second index comprising a set of values, in which each value uniquely represents one of the set of resource block allocation patterns determined in block 875. Moreover, in some embodiments, the size of the second index is less than or equal to the number of resource blocks per resource group (e.g., the number of PRBs per RBG or RBG pair). In some embodiments, as described above, the second index is a bitmap, with each bit uniquely determining the allocation of a particular resource block within the resource group. In some embodiments, also described above, each value of the second index uniquely specifies the allocation of a particular resource block within the resource group. Although not

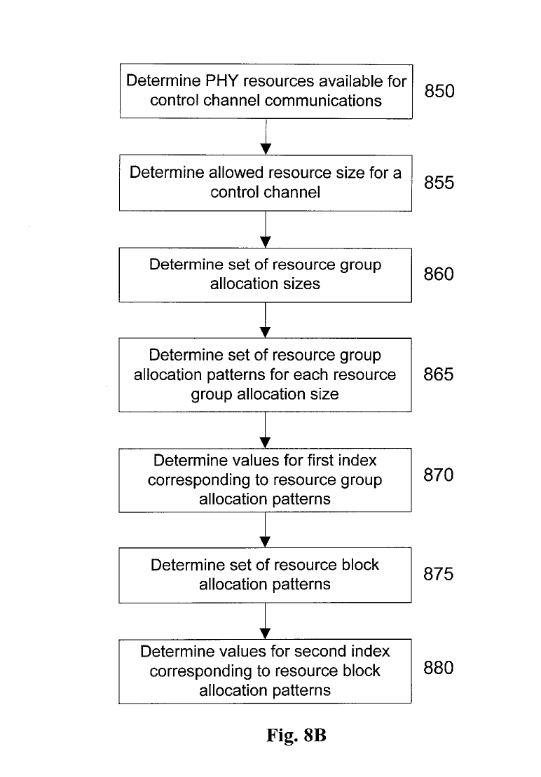

FIG. 9 is a flowchart of an exemplary method for receiving allocation of physical-layer (PHY) resources of a communication system for a control channel, according to one or more embodiments of the present disclosure. In some embodiments, the operations illustrated by FIG. 9 may be carried out by an apparatus such as an eNB, a component of an eNB, or the combination of an eNB with other network components. In other embodiments, the operations illustrated by FIG. 9 may be carried out by an apparatus such as a user equipment (UE) or component thereof (e.g., a modem). Although FIG. 9 illustrates the one or more embodiments by blocks arranged in a specific order, this order is merely exemplary and the steps or operations comprising the method may be performed in a different order than shown in the figure. Moreover, a person of ordinary skill will understand that the blocks shown in FIG. 8A may be combined and/or divided into blocks having different functionality. In block 900, the apparatus receives the system parameters that influence the PHY-layer resource allocation method, including P, the set of available M, the system bandwidth (e.g., N_{PRB}), etc. In some embodiments, the apparatus may receive these parameters from a network equipment (e.g., a eNB in the E-UTRAN) in a broadcast or directed message. In some embodiments, the apparatus may receive one or more of these parameters from a memory in the apparatus in which the parameters are stored. This operation may occur immediately prior to starting the operations of other blocks in FIG. 9, or substantially in advance of such operations.

In some embodiments, in block 905, the apparatus initiates sending of a request for allocation of required ePDCCH resources. This request may comprise a minimum or an expected amount of resources needed for messages planned or expected to be transmitted and/or received via the ePDCCH. For example, the initiation of the request may comprise sending it to a higher layer, such as the RRC layer, through a PHY-layer service access point (SAP), as illustrated in FIG. 2C. Ultimately, a message comprising the request may be sent to a network equipment (e.g., an eNB) responsible for resource allocation via appropriate higher-layer messaging. In block 910, the apparatus determines whether the request sent in block 905 was rejected. If so, the apparatus returns to block 905 where it may make a new request for allocation of resources, e.g., for fewer resources than originally requested. In some embodiments, the apparatus may not send a request for allocation of required resources.

In such embodiments, the operations of blocks 905 and 910 may be omitted from the method. In case the apparatus did not send a request, or if the apparatus determines that the request was not rejected, it proceeds to block 915 where it receives resource allocation indices I_{RP} and I_{PRB}. In some embodiments, indices I_{RP} and I_{PRB} may correspond, respectively, to a set of selected RBGs and one or more PRBs comprising the selected RBGs. In other embodiments, indices I_{RP} and I_{PRB} may correspond, respectively, to a set of selected RBG pairs and one or more PRBs comprising the selected RBG pairs. In any event, the operation in block 915 may comprise extracting these indices from a message comprising other information. In some embodiments, the message may comprise multiple sets of resource allocation indices I_{RP} and I_{PRB}.

In block 920, the apparatus determines the set of thresholds Kᵢ based on the values of index I_{RP}; the set of allowable values of M; and the system bandwidth expressed as N_{RBG}, N^{DL}_{RB}, or in other formats understood by persons of ordinary skill in the art. In block 925, the apparatus selects the threshold Kⱼ that satisfies the inequality Kⱼ≦I_{RP}<Kⱼ₊₁. In the case of M chosen from the set {1, 2}, it will be known that only K₁ satisfies this inequality. In such case the operation in this block may be trivial. In block 930, the apparatus determines resource groups Xᵢ, i=1 . . . M, corresponding to index I_{RP} that comprise PRBs that are allocated to the apparatus for ePDCCH use. In some embodiments, resource groups Xᵢ identify a set of M RBGs. In other embodiments, resource groups X, identify a set of M RBG pairs.

In block 935, the apparatus determines the PRBs comprising the resource groups X, that are allocated for ePDCCH use, based on the value of index I_{PRB}. In some embodiments, this operation comprises selecting one or more of the PRBs comprising each resource group Xᵢ based on the values of the individual bits comprising bitmap I_{PRB}. Depending on the embodiment, each bit in bitmap I_{PRB} may correspond to a single PRB within each resource group or to multiple PRBs within each resource group, as described above. In other embodiments, the operation of block 935 may comprise selecting a single PRB within each resource group Xᵢ based on the value of index I_{PRB}. Depending on the embodiment, each value of index I_{PRB} may correspond to a single PRB within each resource group or to multiple PRBs within each resource group, as described above.

Although not shown in the figure, if the apparatus received multiple pairs of resource allocation indices I_{RP} and I_{PRB} in block 915, it may repeat the operations of blocks 920 through 935 for each pair of resource allocation indices received. After doing so, the apparatus may select a single resource allocation corresponding to one received pair of indices. For example, the apparatus may select the resource allocation that it expects to consume the least amount of energy stored in its battery (i.e., minimize its own power consumption). After identifying the PRBs allocated for ePDCCH use according to the indices I_{RP} and I_{PRB}, in block 940 the apparatus transmits and/or receives ePDCCH messages using the allocated PRBs. This operation may comprise sending an acknowledgement of successful resource allocation—or other appropriate message, such as indication of which of a plurality of received pairs of indices was selected—prior to starting transmission and/or reception via the ePDCCH.

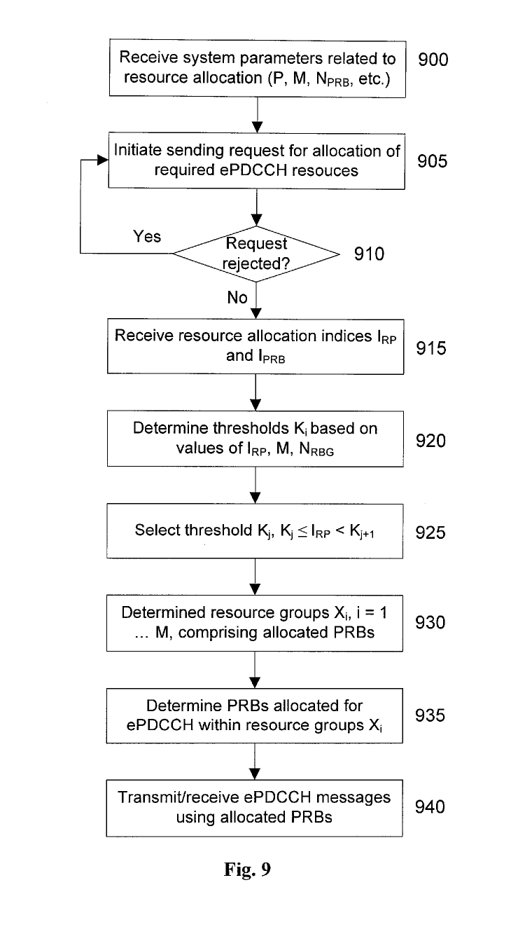

FIG. 10 is a diagram of a PHY layer transmitter 1000 according to one or more embodiments of the present disclosure. In some embodiments, the PHY layer transmitter is capable of performing the method described above with reference to FIG. 9A, mapping PRBs to ePDCCH sets according to one or more of the embodiments described above with reference to FIGS. 5 through 8. Beginning from the left side of FIG. 10, a scrambler 1020 applies scrambling to a block of codewords 1010 representing the coded bits to be transmitted on the physical channel in one subframe. Each codeword in the block of scrambled codewords is then modulated by modulation mapper 1030 using one of the modulation schemes comprising one or more of BPSK, QPSK, 8-PSK, 16-QAM, 64-QAM, or other modulation schemes known to persons of ordinary skill in the art. The output of modulation mapper 1030 is a block of modulated codewords, which are mapped by layer mapper 1040 onto one or several layers, each of which corresponds to one of the available antenna ports 1080. Subsequently, the collection of layers output by layer mapper 1040 are processed by precoder 1050 for spatial multiplexing on the antenna ports 1080, such as by applying cyclic delay diversity (CDD) to the various layers and providing channel state information (CSI).

Next, in the block labeled resource mapper 1060, the block of complex-valued symbols for each of the antenna ports 1080 used for transmission of the physical channel are power-regulated and then mapped to resource elements (REs) in the subframe. This includes mapping into PRBs corresponding to the virtual resource blocks assigned for transmission in that subframe, as well as applying interleaving among PRBs such as described above with reference to FIGS. 6 through 10. Resource mapper 1060 provides resource mapping for all physical channels including PDCCH, ePDCCH, PDSCH, PCFICH, etc. Once all channels have been mapped for each antenna port 1080, OFDM signal generator 1070 generates time-domain subframe signals for each antenna port 1080 using the respective subframes of resource elements. These time-domain signals may then be transmitted on each of the respective antennas.

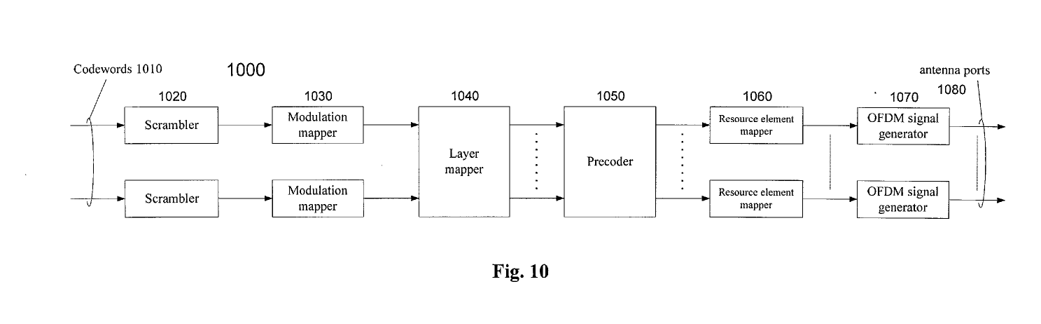

FIG. 11 is a block diagram of exemplary wireless communication device or apparatus, such as a UE or component or subset of a UE (e.g. modem), utilizing certain embodiments of the present disclosure, including one or more of the methods described above with reference to the figures. Device 1100 comprises processor 1110 which is operably connected to program memory 1120 and data memory 1130 via bus 1170, which may comprise parallel address and data buses, serial ports, or other methods and/or structures known to those of ordinary skill in the art. Program memory 1120 comprises software code executed by processor 1110 that enables device 1100 to communicate with one or more other devices using protocols according to various embodiments of the present disclosure, including the LTE PHY protocol layer and improvements thereto, including those described above with reference to FIGS. 6 through 9. Program memory 1120 also comprises software code executed by processor 1110 that enables device 1100 to communicate with one or more other devices using other protocols or protocol layers, such as LTE MAC, RLC, PDCP, and RRC layer protocols standardized by 3GPP, or any improvements thereto; GSM, UMTS, High Speed Packet Access (HSPA), General Packet Radio Service (GPRS), Enhanced Data rate for GSM Evolution (EDGE), and/or CDMA2000 protocols; Internet protocols such as Internet Protocol (IP), Transmission Control Protocol (TCP), User Datagram Protocol (UDP), or others known to persons of ordinary skill in the art; or any other protocols utilized in conjunction with radio transceiver 1140, user interface 1150, and/or host interface 1160. Program memory 1120 further comprises software code executed by processor 1110 to control the functions of device 1100, including configuring and controlling various components such as radio transceiver 1140, user interface 1150, and/or host interface 1160. Such software code may be specified or written using any known or future developed programming language, such as e.g. Java, C++, C, and Assembler, as long as the desired functionality, e.g., as defined by the implemented method steps, is preserved.

Data memory 1130 may comprise memory area for processor 1110 to store variables used in protocols, configuration, control, and other functions of device 1100. As such, program memory 1120 and data memory 1130 may comprise non-volatile memory (e.g., flash memory), volatile memory (e.g., static or dynamic RAM), or a combination thereof. Persons of ordinary skill in the art will recognize that processor 1110 may comprise multiple individual processors (not shown), each of which implements a portion of the functionality described above. In such case, multiple individual processors may be commonly connected to program memory 1120 and data memory 1130 or individually connected to multiple individual program memories and or data memories. More generally, persons of ordinary skill in the art will recognize that various protocols and other functions of device 1100 may be implemented in many different combinations of hardware and software including, but not limited to, application processors, signal processors, general-purpose processors, multi-core processors, ASICs, fixed digital circuitry, programmable digital circuitry, analog baseband circuitry, radio-frequency circuitry, software, firmware, and middleware.

Radio transceiver 1140 may comprise radio-frequency transmitter and/or receiver functionality that enables device 1100 to communicate with other equipment supporting like wireless communication standards. In an exemplary embodiment, radio transceiver 940 includes an LTE transmitter and receiver that enable device 1100 to communicate with various E-UTRANs according to standards promulgated by 3GPP. In some embodiments, radio transceiver 1140 includes circuitry, firmware, etc. necessary for device 1100 to communicate with network equipment using the LTE PHY protocol layer methods and improvements thereto such as those described above with reference to FIGS. 6 through 10. In some embodiments, radio transceiver 1140 includes circuitry, firmware, etc. necessary for device 1100 to communicate with various UTRANs and GERANs. In some embodiments, radio transceiver 1140 includes circuitry, firmware, etc. necessary for device 1100 to communicate with various CDMA2000 networks.

In some embodiments, radio transceiver 1140 is capable of communicating on a plurality of LTE frequency-division-duplex (FDD) frequency bands 1 through 25, as specified in 3GPP standards. In some embodiments, radio transceiver 1140 is capable of communicating on a plurality of LTE time-division-duplex (TDD) frequency bands 33 through 43, as specified in 3GPP standards. In some embodiments, radio transceiver 1140 is capable of communicating on a combination of these LTE FDD and TDD bands, as well as other bands specified in the 3GPP standards. In some embodiments, radio transceiver 1140 is capable of communicating on one or more unlicensed frequency bands, such as the ISM band in the region of 2.4 GHz. The radio functionality particular to each of these embodiments may be coupled with or controlled by other circuitry in device 1100, such as processor 1110 executing protocol program code stored in program memory 1120.

User interface 1150 may take various forms depending on the particular embodiment of device 1100. In some embodiments, device 1100 is a mobile phone, in which case user interface 1150 may comprise a microphone, a loudspeaker, slidable buttons, depressable buttons, a keypad, a keyboard, a display, a touchscreen display, and/or any other user-interface features commonly found on mobile phones. In other embodiments, device 1100 is a data modem capable of being utilized with a host computing device, such as a PCMCIA data card or a modem capable of being plugged into a USB port of the host computing device. In these embodiments, user interface 1150 may be very simple or may utilize features of the host computing device, such as the host device's display and/or keyboard.

Host interface 1160 of device 1100 also may take various forms depending on the particular embodiment of device 1100. In embodiments where device 1100 is a mobile phone, host interface 1160 may comprise a USB interface, an HDMI interface, or the like. In the embodiments where device 1100 is a data modem capable of being utilized with a host computing device, host interface may be a USB or PCMCIA interface.

In some embodiments, device 1100 may comprise more functionality than is shown in FIG. 9. In some embodiments, device 1100 may also comprise functionality such as a video and/or still-image camera, media player, etc., and radio transceiver 1140 may include circuitry necessary to communicate using additional radio-frequency communication standards including GSM, UMTS, High Speed Packet Access (HSPA), General Packet Radio Service (GPRS), Enhanced Data rate for GSM Evolution (EDGE), CDMA2000, LTE, WiFi, Bluetooth, GPS, and/or others. Persons of ordinary skill in the art will recognize the above list of features and radio-frequency communication standards is merely exemplary and not limiting to the scope of the present disclosure. Accordingly, processor 1110 may execute software code stored in program memory 1120 to control such additional functionality.

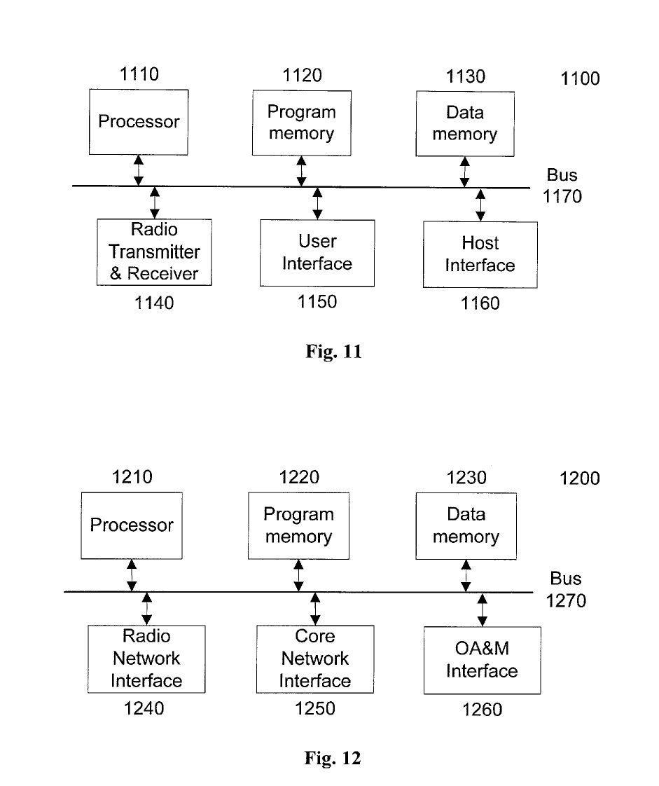

FIG. 12 is a block diagram of an exemplary network equipment 1200 (e.g., an eNB, component of an eNB, or the combination of an eNB with other network components) utilizing certain embodiments of the present disclosure, including those described above with reference to FIGS. 6 through 9. Network equipment 1200 comprises processor 1210 which is operably connected to program memory 1220 and data memory 1230 via bus 1270, which may comprise parallel address and data buses, serial ports, or other methods and/or structures known to those of ordinary skill in the art. Program memory 1220 comprises software code executed by processor 1210 that enables network equipment 1200 to communicate with one or more other devices using protocols according to various embodiments of the present disclosure, including the Radio Resource Control (RRC) protocol and improvements thereto. Program memory 1220 also comprises software code executed by processor 1210 that enables network equipment 1200 to communicate with one or more other devices using other protocols or protocol layers, such as one or more of the PHY, MAC, RLC, PDCP, and RRC layer protocols standardized by 3GPP, or any other higher-layer protocols utilized in conjunction with radio network interface 1240 and core network interface 1250. By way of example and without limitation, core network interface 1250 may comprise the 51 interface and radio network interface 1250 may comprise the Uu interface, as standardized by 3GPP. Program memory 1220 further comprises software code executed by processor 1210 to control the functions of network equipment 1200, including configuring and controlling various components such as radio network interface 1240 and core network interface 1250.

Data memory 1230 may comprise memory area for processor 1210 to store variables used in protocols, configuration, control, and other functions of network equipment 1200. As such, program memory 1220 and data memory 1230 may comprise non-volatile memory (e.g., flash memory, hard disk, etc.), volatile memory (e.g., static or dynamic RAM), network-based (e.g., “cloud”) storage, or a combination thereof. Persons of ordinary skill in the art will recognize that processor 1210 may comprise multiple individual processors (not shown), each of which implements a portion of the functionality described above. In such case, multiple individual processors may be commonly connected to program memory 1220 and data memory 1230 or individually connected to multiple individual program memories and/or data memories. More generally, persons of ordinary skill in the art will recognize that various protocols and other functions of network equipment 1200 may be implemented in many different combinations of hardware and software including, but not limited to, application processors, signal processors, general-purpose processors, multi-core processors, ASICs, fixed digital circuitry, programmable digital circuitry, analog baseband circuitry, radio-frequency circuitry, software, firmware, and middleware.

Radio network interface 1240 may comprise transmitters, receivers, signal processors, ASICs, antennas, beamforming units, and other circuitry that enables network equipment 1200 to communicate with other equipment such as, in some embodiments, a plurality of compatible user equipment (UEs). In some embodiments, radio network interface may comprise various protocols or protocol layers, such as the LTE PHY, MAC, RLC, PDCP, and RRC layer protocols standardized by 3GPP, improvements thereto such as described herein with reference to one of more FIGS. 6 through 10, or any other higher-layer protocols utilized in conjunction with radio network interface 1240. In some embodiments, radio network interface 1240 may comprise the PHY layer transmitter described above with reference to FIG. 10. In some embodiments, the radio network interface 1240 may comprise a PHY layer based on orthogonal frequency division multiplexing (OFDM) or orthogonal frequency division multiple access (OFDMA) technologies.

Core network interface 1250 may comprise transmitters, receivers, and other circuitry that enables network equipment 1200 to communicate with other equipment in a core network such as, in some embodiments, circuit-switched (CS) and/or packet-switched Core (PS) networks. In some embodiments, core network interface 1250 may comprise the 51 interface standardized by 3GPP. In some embodiments, core network interface 1250 may comprise one or more interfaces to one or more SGWs, MMEs, SGSNs, GGSNs, and other physical devices that comprise functionality found in GERAN, UTRAN, E-UTRAN, and CDMA2000 core networks that are known to persons of ordinary skill in the art. In some embodiments, these one or more interfaces may be multiplexed together on a single physical interface. In some embodiments, lower layers of core network interface 1250 may comprise one or more of asynchronous transfer mode (ATM), Internet Protocol (IP)-over-Ethernet, SDH over optical fiber, T1/E1/PDH over a copper wire, microwave radio, or other wired or wireless transmission technologies known to those of ordinary skill in the art.

OA&M interface 1260 may comprise transmitters, receivers, and other circuitry that enables network equipment 1200 to communicate with external networks, computers, databases, and the like for purposes of operations, administration, and maintenance of network equipment 1200 or other network equipment operably connected thereto. Lower layers of OA&M interface 1260 may comprise one or more of asynchronous transfer mode (ATM), Internet Protocol (IP)-over-Ethernet, SDH over optical fiber, T1/E1/PDH over a copper wire, microwave radio, or other wired or wireless transmission technologies known to those of ordinary skill in the art. Moreover, in some embodiments, one or more of radio network interface 1240, core network interface 1250, and OA&M interface 1260 may be multiplexed together on a single physical interface, such as the examples listed above.

As described herein, a device or apparatus may be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. A device or apparatus may be regarded as a device or apparatus, or as an assembly of multiple devices and/or apparatuses, whether functionally in cooperation with or independently of each other. Moreover, devices and apparatuses may be implemented in a distributed fashion throughout a system, so long as the functionality of the device or apparatus is preserved. Such and similar principles are considered as known to a skilled person.

More generally, even though the present disclosure and exemplary embodiments are described above with reference to the examples according to the accompanying drawings, it is to be understood that they are not restricted thereto. Rather, it is apparent to those skilled in the art that the disclosed embodiments can be modified in many ways without departing from the scope of the disclosure herein. Moreover, the terms and descriptions used herein are set forth by way of illustration only and are not meant as limitations. Those skilled in the art will recognize that many variations are possible within the spirit and scope of the disclosure as defined in the following claims, and their equivalents, in which all terms are to be understood in their broadest possible sense unless otherwise indicated.

1. A computer-implemented method for allocating physical-layer (PHY) resources of a communication system for a control channel, comprising:
receiving a request for allocating of PHY resources for a control channel;
determining a set of resource allocation patterns from among all available resource allocation patterns;
selecting at least one resource allocation pattern from the determined set of resource allocation patterns;
encoding a plurality of indices identifying each of the at least one selected resource allocation patterns, wherein the plurality of indices comprises a first index identifying a selected resource group allocation and a second index identifying a selected resource block allocation;
sending a message comprising the plurality of indices for each of the at least one selected resource allocation patterns.

2. The method of claim 1, wherein:
the physical layer (PHY) comprises a Long Term Evolution (LTE) physical layer;
the control channel comprises an enhanced Physical Downlink Control Channel (ePDCCH);
each resource group allocation comprises one or more physical resource block groups (RBGs); and
each resource block allocation comprises one or more physical resource blocks (PRBs) within the one or more RBGs.

3. The method of claim 2, wherein the first index identifies one of the following resource groups: one or more RBGs and one or more pairs of RBGs.

4. The method of claim 3, wherein the second index identifies one or more PRBs comprising the resource groups identified by the first index, wherein the size of the second index is less than or equal to the number of PRBs per RBG.

5. The method of claim 4, wherein the second index comprises a bitmap in which the value of each bit identifies whether a single PRB associated with that bit is allocated by the resource allocation pattern.

6. The method of claim 4, wherein the second index comprises a bitmap in which the value of each bit identifies whether a pair of PRBs associated with that bit is allocated by the resource allocation pattern.

7-27. (canceled)

28. An apparatus, comprising:
a transmitter;
a receiver;
at least one processor; and
at least one memory comprising program code that, when executed by the at least one processor, causes the apparatus to:
receive a request for allocating physical-layer (PHY) resources of a communication system for a control channel;
determine a set of resource allocation patterns from among all available resource allocation patterns;
select at least one resource allocation pattern from the determined set of resource allocation patterns;
encode a plurality of indices identifying each of the at least one selected resource allocation patterns, wherein the plurality of indices comprises a first index identifying a selected resource group allocation and a second index identifying a selected resource block allocation;
send a message comprising the plurality of indices for each of the at least one selected resource allocation patterns.

29. The apparatus of claim 28, wherein:
the physical layer (PHY) comprises a Long Term Evolution (LTE) physical layer;
the control channel comprises an enhanced Physical Downlink Control Channel (ePDCCH);
each resource group allocation comprises one or more physical resource block groups (RBGs); and
each resource block allocation comprises one or more physical resource blocks (PRBs) within the one or more RBGs.

30. The apparatus of claim 29, wherein the apparatus comprises one of an evolved Node B (eNB) and a user equipment (UE).

31. The apparatus of claim 29, wherein the first index identifies one of the following resource groups: one or more RBGs and one or more pairs of RBGs.

32. The apparatus of claim 31, wherein the second index identifies one or more PRBs comprising the resource groups identified by the first index, wherein the size of the second index is less than or equal to the number of PRBs per RBG.

33. The apparatus of claim 32, wherein the second index comprises a bitmap in which the value of each bit identifies whether a single PRB associated with that bit is allocated by the resource allocation pattern.

34. The apparatus of claim 32, wherein the second index comprises a bitmap in which the value of each bit identifies whether a pair of PRBs associated with that bit is allocated by the resource allocation pattern.

35. The apparatus of claim 32, wherein the value of the second index uniquely identifies whether a particular PRB is allocated by the resource allocation pattern.

36. The apparatus of claim 32, wherein the value of the second index uniquely identifies whether a particular pair of PRBs is allocated by the resource allocation pattern.

37. The apparatus of claim 29, wherein the total number of PRBs within each RBG is determined from the bandwidth of the PHY resources of the communication system.

38. The apparatus of claim 28, wherein the set of resource allocation patterns is determined based on at least the bandwidth of the communication system and the allowed resource size for a control channel.

39. The apparatus of claim 28, wherein the first index is encoded using ceil(log₂(N)) bits, wherein N is the total number of unique resource group allocations among all available resource allocation patterns.

40. The apparatus of claim 29, wherein the number of physical resource block groups (RBGs) associated with any of the available resource allocation patterns is determined from the bandwidth of the PHY resources.

41-55. (canceled)

56. A computer readable medium comprising a set of instructions that, when executed by at least one processor comprising an apparatus, causes the apparatus to:
receive a request for allocating physical-layer (PHY) resources of a communication system for a control channel;
determine a set of resource allocation patterns from among all available resource allocation patterns;
select at least one resource allocation pattern from the determined set of resource allocation patterns;
encode a plurality of indices identifying each of the at least one selected resource allocation patterns, wherein the plurality of indices comprises a first index identifying a selected resource group allocation and a second index identifying a selected resource block allocation; and
send a message comprising the plurality of indices for each of the at least one selected resource allocation patterns.

57-111. (canceled)
